(19) United States
(12) Patent Application Publication
(10) Pub. No.: US 2020/0130145 A1
(43) Pub. Date: Apr. 30, 2020

(54) HAND TOOL WITH ADJUSTABLE RELEASE FUNCTION

(71) Applicant: PRESSMASTER AB, Älvdalen (SE)

(72) Inventors: Niklas JONASSON, Färnäs (SE); Marco ENDLER, Älvdalen (SE)

(73) Assignee: PRESSMASTER AB, Älvdalen (SE)

(21) Appl. No.: 16/605,589

(22) PCT Filed: Apr. 26, 2018
(86) PCT No.: PCT/SE2018/050429

§ 371 Date: Oct. 16, 2019

(30) Foreign Application Priority Data
Apr. 28, 2017 (SE) 1750518-1

(51) Int. Cl. B25B 7/16; H01R 43/042

(52) U.S. Cl. CPC B25B 7/16; H01R 43/042

(57) ABSTRACT

A hand tool with a clampable operating area at an upper part of the tool, and two opposed handles extending to a lower part of the tool and being arranged to govern the clampable operating area between an open and a closed position, wherein a toothed pin is pivotally arranged between the handles extending downwards, wherein a support and a pawl are arranged on a first handle of the two handles at a distance from each other forming a space between them, in which space the toothed pin is to be received, and wherein an interaction of the toothed pin and the pawl impedes reverse motion of the handles during a closing action thereof, The interaction of the toothed pin and the pawl is such that reverse motion of the handles becomes possible at a specific release point that corresponds to a specific relative position of the handles.

### TECHNICAL FIELD

The invention relates to a hand tool with a back stop for impeding reverse motion of the hand tool's handles during a closing operation. Specifically, the invention relates to such a hand tool where the back stop has a release point at which point reverse motion will become possible.

### BACKGROUND

In many applications where precision hand tool, such as crimping pliers, wire cutter or the like are utilized a back stop for impeding reverse motion of the hand tool's handles during a closing operation is arranged. Further, such back stops preferably include a release function with a release point at which point reverse motion of the handles will become possible. In some applications it is further possible to adjust the release point, such that the back stop is released at a specific position corresponding to a specific jaw formation.

In U.S. Pat. No. 3,063,313 a crimping tool is disclosed, which comprises a crescent gear and a release function. Two handles are arranged and crimping dies are governed by the action of the handle. An adjustment device is arranged to control the crimping space, such that the crimping space has a desired size when the crescent gear is released.

Another arrangement is known from U.S. Pat. No. 9,556,691 in which a multi-functional tool has a biased crescent gear arranged on a link arm extending between the handles of the tool. An adjustment screw is arranged to adjust the height of a first end of the link arm to thereby control the distance between the handles in the open position.

Both the above arrangements achieve back-stop function with some kind of possibility of adaptation. However, in both arrangements the adaptation also controls the operating area, i.e. the position of the crimping dies or the distance between the gripping jaws. For precision tools this may be a disadvantage, because the operating area may be very precisely designed, such that any alteration thereof is undesired. However, there may be other reasons to provide a possibility to adjust a back-stop arrangement.

Hence, there is a need of an arrangement for a precision hand tool that allows a possibility to adjust a back-stop function without tampering the co-operation of the jaws or operating area of the hand tool.

### SUMMARY OF THE INVENTION

It is an object of the present invention to provide hand tool that allows a possibility to adjust a back-stop function without tampering the co-operation of the handles and the operating area of the hand tool.

The invention relates to a hand tool with a clampable operating area at an upper part of the tool, and two opposed handles extending to a lower part of the tool and being arranged to govern the clampable operating area between an open and a closed position, wherein a toothed pin is pivotally arranged between the handles extending downwards, wherein an arrangement is arranged for impeding reverse motion of the handles during a closing action thereof is such that reverse motion of the handles becomes possible at a specific release point that corresponds to a specific relative position of the handle. An adjustment device is arranged to adjust said release point without affecting the specific relation between the handle and the clampable operating area.

With the inventive arrangement it is possible to adjust the release point of a back stop function without tampering the co-operation of the jaws or operating area of the hand tool. This is advantageous because it makes sure that the function of the tool is not compromised by altering the relation between pivot points and the like involved in the link system connecting the handles and the jaws. Thereby the precision may be guaranteed at all times, and irrespective of a current adjustment of position.

In a specific embodiment, the release point is arranged to occur at a point where the clampable operating area is closed and wherein the adjustment device is arranged to adjust the specific relative position of the handles at which said release point occurs.

In one specific embodiment the arrangement for impeding reverse motion of the handles during a closing action thereof comprises a toothed pin that is pivotally arranged between the handles and extend downwards, wherein a support and a pawl are arranged on a first handle of the two handles at a distance from each other forming a space between them, in which space the toothed pin is to be received, and wherein an interaction of the toothed pin and the pawl impedes reverse motion of the handles during a closing action thereof and that the interaction of the toothed pin and the pawl is such that reverse motion of the handles becomes possible at a specific release point that corresponds to a specific relative position of the toothed pin and the pawl.

In a specific embodiment, the release point is arranged to occur at a point where the clampable operating area is closed and wherein the adjustment device is arranged to adjust the specific relative position of the handles at which the interaction of the toothed pin and the pawl is released.

In one embodiment the handles are such arranged with respect to each other that the handles may be pushed towards each other even after the clampable operating area has reached a fully closed position.

In one embodiment the toothed pin comprises a free space in which the pawl may rotate to a position that allows reverse motion of the toothed pin, said mutual position of the pawl and the toothed pin corresponding to the release point.

In one embodiment the adjustment device is part of the support, the support being movable between different positions, each position corresponding to a specific interaction between the toothed pin and the pawl and to a specific release point.

In one embodiment the support is arranged on the first handle via a pin and an indented track with multiple defined positions for the pin, each position of the support corresponding to a specific position of the pin inside one of the multiple defined positions of the track.

In one embodiment the toothed pin is unbiased, freely pivotally arranged.

In one embodiment the pawl is biased into contact with the toothed pin.

In one embodiment a link arm is arranged, wherein the toothed pin is pivotally arranged on said link arm.

Other embodiments and advantages will be apparent from the detailed description and the appended drawings.

### BRIEF DESCRIPTION OF DRAWINGS

An exemplary embodiment related to the invention will now be described with reference to the appended drawings, of which;

FIG. 1 shows an embodiment of a hand tool in an open position;

FIGS. 2-3 are detailed views of a hand tool in an open position with a back-stop arrangement adjusted to two different modes;

FIGS. 4-5 show a hand tool in a closed position with the back-stop arrangement adjusted to different modes;

FIG. 6 is a detailed view of the back-stop arrangement adjusted to a maximal mode;

FIG. 7 shows a hand tool in a closed position with the back-stop arrangement in a release position; and

FIG. 8 is a detailed view of the back-stop arrangement as shown in FIG. 7.

### DETAILED DESCRIPTION OF EMBODIMENTS

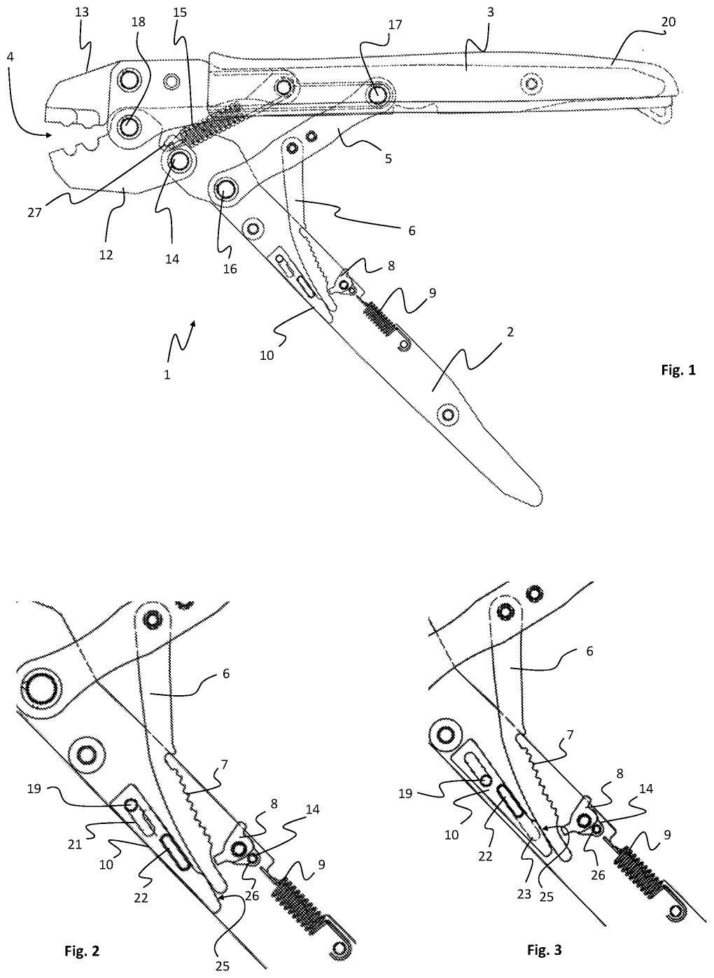

In FIG. 1 a hand tool 1 in accordance with a first embodiment of the invention is shown in an open mode with the handles 2 and 3 arranged apart from each other. In use, the handles 2 and are provided with grips, typically made of a plastic material. In the figures only the second handle 3 is provided with a grip 20. For clarity, no grip is provided on the first handle 2 in the figures. The mutual position of the handles 2 and 3 controls an operating area 4 arranged between two jaws 12 and 13. The jaws 12 and 13 are arranged at an upper end of the hand tool 1 and the handles 2 and 3 extend downwards towards the lower end of the hand tool. The operating area 4 is adapted to receiving an item to be clamped or cut such as an electric contact or a wire, respectively. The invention is not limited to a specific hand tool, only to a hand tool comprising two handles. In the following description the inventive hand tool is exemplified by a clamping tool for clamping electric contacts.

In the shown embodiment, a link arm 5 is arranged between the handles 2 and 3 and a toothed pin 6 is pivotally arranged on said link arm 5. A first end of the link arm 5 is arranged at a connection point 16 on an upper part of a first handle 2 of the two handles, close to the pivot point 14 thereof. The opposite end of the link arm 5 is arranged at a connection point 17, farther down on the handle and preferably close to the middle of said second handle 3.

The jaws 12 and 13 are connected in a pivot point 18, wherein the operating area 4 is formed between active parts of the jaws above said pivot point 18. The lower part of the first jaw 12 is connected via the pivot link 14 to the first handle 2 and the lower part of the second jaw 13 is fixedly connected to the second handle 3. A return spring 15 is arranged to pull the jaws apart and hence to pull the handles apart towards an initial spread position of the hand tool 1. In the shown embodiment, the return spring 15 is arranged between the second handle 3 and the first jaw 12 at a return spring connection 27 close to the pivot point 14 between the first handle 2 and the first jaw 12. It may however be arranged at other locations achieving the same spreading effect of the handles. The spring may also be a leaf spring or the like arranged to push the handles apart. Further, the tool may be provided without return spring, wherein the handles would need to be manually pulled apart after each work operation.

An arrangement is arranged for impeding reverse motion of the handles during a closing action thereof is such that reverse motion of the handles becomes possible at a specific release point that corresponds to a specific relative position of the handles. In the shown embodiment this arrangement is comprised of a toothed pin 6 interacting with a pawl 8.

In the shown embodiment the toothed pin 6 extends downwards from the link arm 5, i.e. away from the jaws 12 and 13, wherein the free end of the toothed pin 6 extends along the first handle 2. This is shown in detail in FIGS. 2 and 3. A pawl 8 is arranged in connection to the first handle 2 to interact with the toothed pin 6. Specifically, as the handles are pulled towards each other the toothed pin 6 is arranged to pass the pawl 8 tooth by tooth, wherein the interaction between the pawl 8 and each tooth 7 stops the toothed pin 6 from moving backwards with respect to the pawl 8, and hence, the handles 2 and 3 are prevented from moving away from each other during a closing operation. A spring 9 is arranged to turn the pawl 8 into interaction with the teeth 7 of the toothed pin 6. The spring 9 is arranged in pawl spring connection 26 at a side portion 24 of the pawl 8 so as to act on the pawl towards a position where the tip of the pawl points towards the toothed pin 6.

In the figures both the pawl spring 9 and the return spring 15 are shown in an unaffected state, wherein one end thereof is disconnected from its position. The pawl spring 9 is hence not connected to the pawl spring connection 26 on the pawl 8, and the return spring 15 is not connected to the return spring connection 27 on the first jaw 12. From this is also to be understood that both springs arranged in a stretched position whereby the spring action will act to retract the respective springs.

A support 10 is arranged to support the toothed pin 6 and keep the teeth 7 thereof in interaction with the pawl 8. The support 10 is arranged to keep the toothed pin 6 so close to the pawl 8 such the tip thereof will be forced in either direction, interacting with either the front or back sides of the teeth 7. The spring 9 will make sure that the tip of the pawl 8 will be kept in contact with the teeth 7 of the toothed pin 6.

In both FIGS. 2 and 3 the handles are in an open position, spread away from each other. A difference between figures is the position of the support 10. Namely, the support 10 is adaptable between a number of positions, which will control a release point of the pawl 8 with respect to the toothed pin 6. In FIG. 2 the support is shown in a maximal position, which is maximal in that it allows maximal clamping of the handles before the pawl is released, and in FIG. 3 the support is shown in a minimal position, which signifies that the pawl 8 is released at a point where the handles have been pulled together minimally. Minimally should however be construed as a point where the jaws have reached into contact, wherein further movement of the handles towards each other would increase the force between the jaws, but not bring them closer together unless an item, e.g. a contact to be crimped, is hindering their way towards each other.

In the shown embodiment the support 10 comprises an indented track 21 which is adapted to interact with a pin 19 arranged on the first handle 2. Further, the support comprises a protrusion 22 arranged to slide in a guide 23 in the form of a track arranged on the first handle 2. The protrusion 22 preferably has an elongate shape with a width adapted to fit tightly inside the guide to thereby guide the support 10 with precision. Of course, as is obvious to a person skilled in the art, the support 10 may be arranged in other ways that allows it to be movable with respect to the first handle and adjustable with respect to the toothed pin 6. The support 10 comprises a support surface 25 arranged to remain in contact with the back side of the toothed pin 6. The support 10 is adjusted by moving it diagonally such that the support surface 25 is moved towards the toothed pin 6, whereby the mutual position between the toothed pin 6 and the pawl 8 will be altered in either direction.

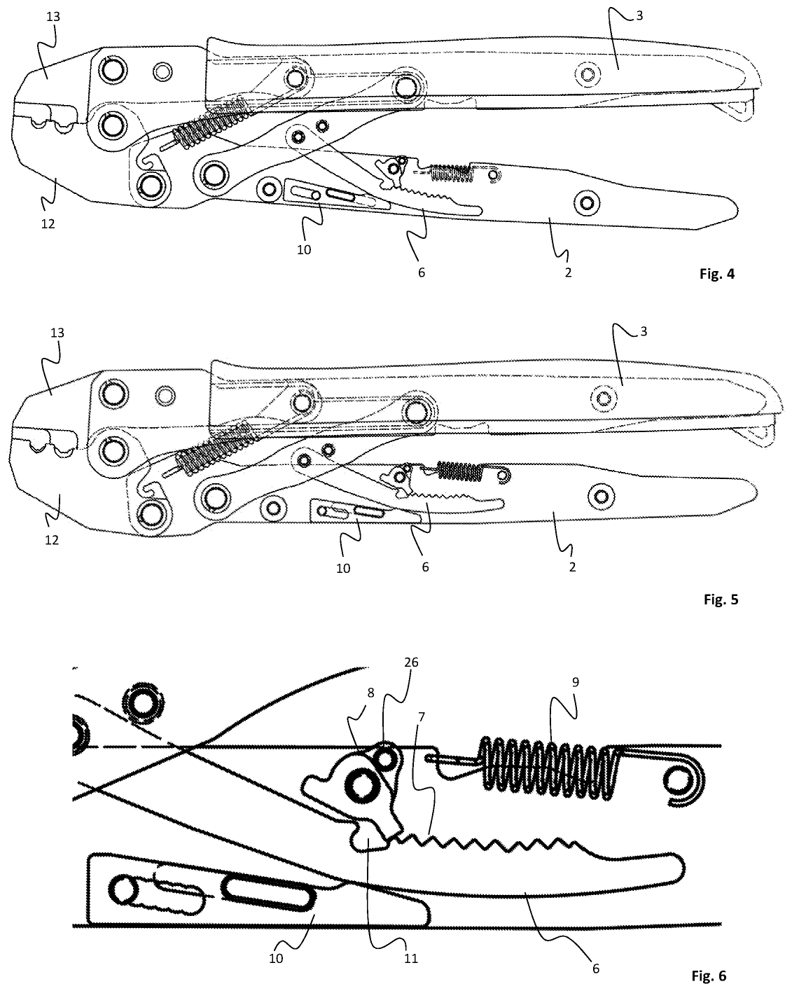

In FIGS. 4 and 5 the hand tool 1 is shown in a position just before the back-stop function of the pawl 8 and toothed pin 6 is released. In FIG. 4 the support 10 is positioned in a position corresponding to the minimal mode of the back-stop function, and in FIG. 5 the support 10 is positioned in a position corresponding to the maximal mode of the back-stop function. This is inter alia apparent in that the handles 2 and 3 are closer together in the maximal mode as represented in FIG. 5 than in the minimal mode of FIG. 4.

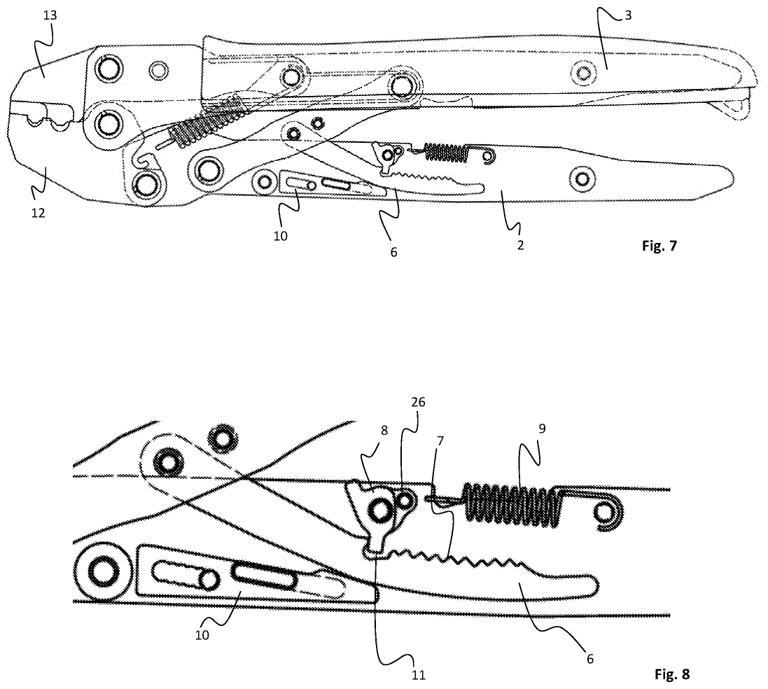

A detailed view of the back-stop function corresponding to the maximal mode is shown in FIG. 6. In FIG. 6, it is apparent that the pawl 8 rests at the last tooth of the teeth 7 on the toothed pin 6. Further movement of the handles towards each other will cause the toothed pin 6 downwards along the first handle 2, i.e. to the right in FIG. 6, such that the last tooth will pass the pawl 8 and allow the pawl 8 to swing, clockwise in the figure, into a position where it will allow the toothed pin 6 to be returned and the handles 2 and 3 to be retracted from each other. This position is shown in FIGS. 7 and 8, of which FIG. 8 is a detailed view of the back-stop arrangement.

In FIG. 8 it is apparent that the tip of the pawl 8 has reached a position inside a free space 11 in which the pawl 8 is allowed to turn, such that the tip thereof will be redirected towards the left in the figure. In the shown embodiment, the interaction between the pawl 8 and the toothed pin 6 is double-sided, such that said interaction will prevent reverse motion also as the handles are pulled apart. This is achieved in that the teeth 7 of the toothed pin 6 are symmetric with similar front and back sides. In a possible embodiment, the teeth are arranged with one steep side only, the other side having a slope that allows passage of the pawl.

As is visible in FIGS. 2 and 3 no teeth are arranged on the outer free end of the toothed pin 6 and space is available at said free end for the pawl 8 to swing into a neutral position, which will allow it to be correctly positioned when the handles will be brought together in a subsequent clamping operation.

As an alternative to adjusting the release point by adjustment of the position of the support it would also be possible to adjust the pivot point of the toothed pin or to adjust the position of pawl with respect to the toothed pin. All these alternatives would provide the inventive object of being able to adjust the release point without affecting the specific relation between the handles 2,3 and the clampable operating area 4.

An advantage of the double acting toothed pin 6 of the shown embodiment is that it encourages correct usage of the hand tool 1, by forcing the operator to both fully complete a clamping operation and to fully retract the handles after a completed operation.

Above, the invention has been described with reference to specific embodiments. The invention is however not limited to these embodiments. It is obvious to a person skilled in the art that other embodiments are possible within the scope of the following claims.

1. A hand tool with a clampable operating area at an upper part of the tool, and two opposed handles extending to a lower part of the tool and being arranged to govern the clampable operating area between an open and a closed position according to specific relation, wherein an arrangement is arranged for impeding reverse motion of the handles during a closing action thereof is such that reverse motion of the handles becomes possible at a specific release point that corresponds to a specific relative position of the handles, characterised in that an adjustment device is arranged to adjust said release point without affecting the specific relation between the handles and the clampable operating area, wherein the arrangement for impeding reverse motion of the handles during a closing action thereof comprises a toothed pin that is pivotally arranged between the handles and extends downwards, wherein a support and a pawl are arranged on a first handle of the two handles at a distance from each other forming a space between them, in which space the toothed pin is to be received, and wherein an interaction of the toothed pin and the pawl impedes reverse motion of the handles during a closing action thereof and that the interaction of the toothed pin and the pawl is such that reverse motion of the handles becomes possible at a specific release point that corresponds to a specific relative position of the toothed pin and the pawl.

2. The hand tool according to claim 1, wherein a link arm is arranged between the handles, and wherein the toothed pin is pivotally arranged on said link arm.

3. The hand tool (1) according to claim 1, wherein the toothed pin comprises a free space in which the pawl may rotate to a position that allows reverse motion of the toothed pin, said mutual position of the pawl and the toothed pin corresponding to the release point.

4. The hand tool according to claim 1, wherein the adjustment device is part of the support, the support being movable between different positions, each position corresponding to a specific interaction between the toothed pin and the pawl and to a specific release point.

5. The hand tool according to claim 4, wherein the support is arranged on the first handle via a pin and an indented track with multiple defined positions for the pin, each position of the support corresponding to a specific position of the pin inside one of the multiple defined positions of the track.

6. The hand tool according to claim 1, wherein the toothed pin is unbiased, freely pivotally arranged.

7. The hand tool according to claim 1, wherein the pawl is biased into contact with the toothed pin.

8. The hand tool according to claim 1, wherein the release point is arranged to occur at a point where the clampable operating area is closed and wherein the adjustment device is arranged to adjust the specific relative position of the handles at which said release point occurs.
